(19) United States
(12) Patent Application Publication
(10) Pub. No.: US 2019/0390984 A1
(43) Pub. Date: Dec. 26, 2019

(54) ANGLE DETECTION DEVICE

(71) Applicant: HITACHI AUTOMOTIVE SYSTEMS, LTD., Hitachinaka-shi, Ibaraki (JP)

(72) Inventor: Eiichirou OOHATA, Tokyo (JP)

(73) Assignee: HITACHI AUTOMOTIVE SYSTEMS, LTD., Hitachinaka-shi, Ibaraki (JP)

(21) Appl. No.: 16/466,452

(22) PCT Filed: Jan. 25, 2018
(86) PCT No.: PCT/JP2018/002200

§ 371 Date: Jun. 4, 2019

(30) Foreign Application Priority Data
Feb. 20, 2017 (JP) 2017-029155

(51) Int. Cl. G01D 5/244

(52) U.S. Cl. CPC G01D 5/24476

(57) ABSTRACT

Provided is an angle detection device capable of easily disposing sensors and suppressing a detection error of a rotation angle by correcting a detection error of a rotation angle due to eccentricity of a signal rotor. Therefore, an angle detection device includes a first position detection sensor, a second position detection sensor, and a signal rotor and detects a rotation angle of a crankshaft to which the signal rotor is attached. The signal rotor is provided with an angle detector and a distance detector along its axial direction. The first position detection sensor is provided to face the angle detector in the radial direction of the signal rotor. The second position detection sensor is provided to face the distance detector in the radial direction and is disposed side by side with the first position detection sensor in the axial direction.

### TECHNICAL FIELD

The present invention relates to an angle detection device for detecting a rotation angle of a rotating body such as a crankshaft of an engine.

### BACKGROUND ART

Engines for automobiles are provided with an angle detection device to detect a rotation angle of a crankshaft. This angle detection device includes a signal rotor formed with teeth and attached to a crankshaft and two sensors disposed to face each other on the outside of the teeth along a radial direction of the signal rotor (refer to, for example, PTL 1).

Then, by calculating an average period of signals output by the two sensors, a detection error of a rotation angle due to eccentricity of the crankshaft and eccentricity at the time of attaching of the signal rotor is corrected.

### CITATION LIST

### Patent Literature

PTL 1: JP 2006-98392 A

### SUMMARY OF INVENTION

### Technical Problem

However, in the configuration of a conventional angle detection device, although it is necessary to dispose two sensors to face each other in the radial direction on the outer periphery of a signal rotor, it is difficult to dispose the sensors at the positions in an actual engine. Therefore, one of the sensors needs to be disposed at a high temperature position, and a heat countermeasure is also required.

The present invention has been made in view of such problems, and its object is to provide an angle detection device capable of easily disposing sensors and suppressing a detection error of a rotation angle by correcting a detection error of a rotation angle due to eccentricity of a signal rotor.

### Solution to Problem

To achieve the above object, an angle detection device according to an embodiment of the present invention includes a first position detection sensor, a second position detection sensor, and a signal rotor. The angle detection device detects a rotation angle of a rotating body to which the signal rotor is attached. The signal rotor is provided with an angle detector and a distance detector along an axial direction of the signal rotor. The first position detection sensor is provided to face the angle detector in a radial direction of the signal rotor. The second position detection sensor is provided to face the distance detector in the radial direction and is disposed side by side with the first position detection sensor in the axial direction.

### Advantageous Effects of Invention

According to the present invention, an angle detection device can be provided which is capable of easily disposing sensors and suppressing a detection error of a rotation angle by correcting a detection error of a rotation angle due to eccentricity of a signal rotor.

### BRIEF DESCRIPTION OF DRAWINGS

FIG. 1 illustrates an overall configuration of an angle detection device according to the present embodiment, FIG. 1(a) is a front view, and FIG. 1(b) is a side view.

FIG. 2 is a diagram indicating an output signal output by a first position detection sensor.

FIG. 3 is a graph indicating a relationship between a crank angle and a signal period.

FIG. 4 is a graph indicating a relationship between a crank angle and a detected distance.

FIG. 5 explain a procedure for correcting a rotation angle of a signal rotor.

### DESCRIPTION OF EMBODIMENTS

Hereinafter, an angle detection device 1 according to an embodiment of the present invention will be described with reference to the drawings.

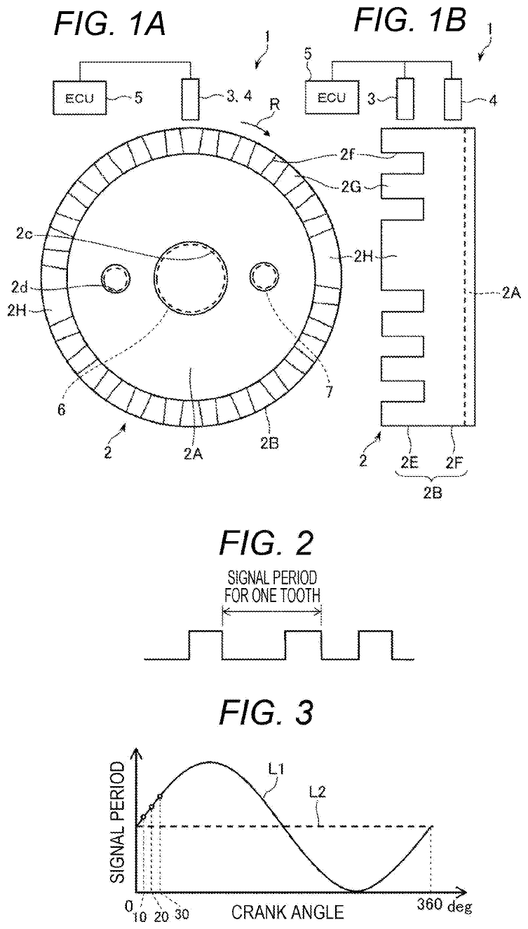

FIG. 1 illustrates an overall configuration of the angle detection device 1 according to the present embodiment, FIG. 1(a) is a front view, and FIG. 1(b) is a side view. FIG. 2 is a diagram indicating an output signal output by a first position detection sensor 3.

As illustrated in FIG. 1, the angle detection device 1 includes a signal rotor 2, a first position detection sensor 3, a second position detection sensor 4, and an engine control unit (ECU) 5.

The signal rotor 2 is made of a magnetic material and includes a disk portion 2A and a cylindrical portion 2B. In the disk portion 2A, an insertion hole 2c for inserting a crankshaft 6 which is a rotating body, and a mounting hole 2d for attaching the signal rotor 2 to the crankshaft 6 with a screw 7 are formed.

The cylindrical portion 2B is provided to axially project along an outer peripheral edge of the disk portion 2A. As illustrated in FIG. 1(b), the cylindrical portion 2B includes an angle detector 2E positioned on one side in the axial direction and a distance detector 2F positioned on the other side in the axial direction. The angle detector 2E is configured of a plurality of notches 2f formed at equal angular intervals and a remaining portion (a plurality of teeth) 2G. The angle detector 2E is a portion that is a reference of a rotation angle of the crankshaft 6, and includes a pair of reference portions 2H which are not formed with the notches 2f and wider than the teeth 2G. The distance detector 2F is connected to the disk portion 2A and has a cylindrical shape.

The first position detection sensor 3 is a magnetic sensor including a permanent magnet, a magnetic field detection element, and the like, and is a sensor for detecting a rotation angle of the signal rotor 2. The first position detection sensor 3 is disposed to face the outer peripheral surface of the angle detector 2E of the signal rotor 2 in the radial direction of the signal rotor 2 and detects positions of the notches 2f and the teeth 2G of the angle detector 2E and outputs a detection signal (a signal period for each tooth) as illustrated in FIG. 2.

The second position detection sensor 4 is a magnetic sensor including a permanent magnet, a magnetic field detection element, and the like, and is disposed to face the outer peripheral surface of the distance detector 2F of the signal rotor 2 in the radial direction of the signal rotor 2. The second position detection sensor 4 detects a distance from its tip to the outer peripheral surface of the distance detector 2F of the signal rotor 2 and outputs a detection signal.

As described later, the ECU 5 corrects an error due to eccentricity of the signal rotor 2 of the rotation angle detected by the first position detection sensor 3 based on detection signals output from the first position detection sensor 3 and the second position detection sensor 4.

Hereinafter, a method of correcting an error of the rotation angle detected by the first position detection sensor 3 due to the eccentricity of the rotation axis of the signal rotor 2 will be described.

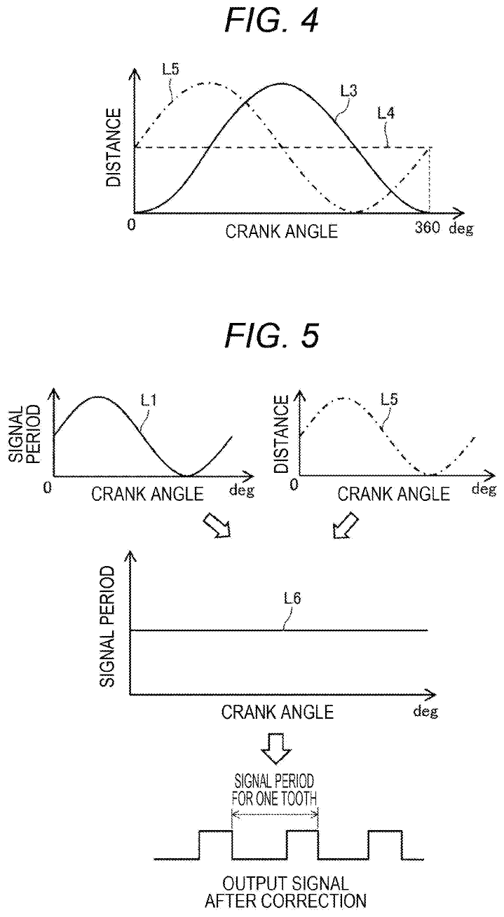

FIG. 3 is a graph indicating a relationship between a crank angle and a signal period. FIG. 4 is a graph indicating a relationship between a crank angle and a detected distance. FIG. 5 explain a procedure for correcting a rotation angle of the signal rotor 2.

In the case where the rotation axis of the signal rotor 2 is eccentric, the first position detection sensor 3 detects the rotation angle of the signal rotor 2 rotating at a constant speed, and when the relationship between the crank angle output by the first position detection sensor 3 and the signal period is graphed, the relationship indicated by the solid line L1 in FIG. 3 is obtained. If the rotation axis of the signal rotor 2 is not eccentric, the relationship between the crank angle and the signal period can be a straight line (constant value) as indicated by the dotted line L2. However, since the rotation axis of the signal rotor 2 is eccentric, the relationship becomes a sinusoidal curve as indicated by the solid line L1. Therefore, the difference between the solid line L1 and the dotted line L2 at each crank angle corresponds to an error of the rotation angle due to the eccentricity of the signal rotor 2.

That is, as illustrated in FIG. 1, in the case where the signal rotor 2 rotates at a constant speed in the arrow R direction, and the signal rotor 2 swings to the left and right due to eccentricity, when the signal rotor 2 swings from right to left, since the rotational speed of the signal rotor 2 passing near the first position detection sensor 3 becomes relatively slow, the signal period becomes long as indicated by a peak portion of the solid line L1. On the other hand, when the signal rotor 2 swings from the left to the right, since the rotational speed of the signal rotor 2 passing near the first position detection sensor 3 becomes relatively fast, the signal period becomes short as indicated by a valley portion of the solid line L1. In addition, when the signal rotor 2 is located at the rightmost and leftmost positions, there is no relative change in the rotational speed of the signal rotor 2 passing near the first position detection sensor 3, and the signal period is an intermediate value between the peak portion and the valley portion.

In addition, in the case where the rotation axis of the signal rotor 2 is eccentric, the second position detection sensor 4 detects a distance to the outer peripheral surface of the distance detector 2F of the signal rotor 2, and when the relationship between the crank angle and the detected distance is graphed, a relationship as indicated by the solid line L3 in FIG. 4 is obtained. If the rotation axis of the signal rotor 2 is not eccentric, the relationship between the crank angle and the distance can be a straight line (constant value) as indicated by the dotted line L4. However, since the rotation axis of the signal rotor 2 is eccentric, the relationship becomes a sinusoidal curve as indicated by the solid line L3.

That is, the signal rotor 2 rotates at a constant speed in the direction of arrow R, and the signal rotor 2 swings to the left and right due to eccentricity. When the second position detection sensor 4 is disposed so as to be closest to the signal rotor 2 in the rightmost state (0°), when the signal rotor 2 rotates 180° and moves to the leftmost, the second position detection sensor 4 is most distant from the signal rotor 2. Accordingly, the vicinity of 0° of the signal rotor 2 corresponds to the valley portion of the solid line L3, and the vicinity of 180° corresponds to the peak portion of the solid line L3. In addition, when the signal rotor 2 is rotated by 90° or 270°, the distance between the signal rotor 2 and the second position detection sensor 4 is an intermediate value. As described above, the eccentricity of the signal rotor 2 is measured by measuring the distance to the signal rotor 2 by the second position detection sensor 4.

As illustrated in FIGS. 3 and 4, the solid line L1 indicating the relationship between the crank angle and the signal period is 90° out of phase with the solid line L3 indicating the relationship between the crank angle and the detected distance. More specifically, the solid line L3 indicating the relationship between the crank angle and the detected distance is 90° behind phase with the solid line L1 indicating the relationship between the crank angle and the signal period.

The ECU 5 differentiates the solid line L3 indicating the relationship between the crank angle and the detected distance and obtains a curve as indicated by the alternate long and short dash line L5 in FIG. 4. Thus, the phase of the solid line L3 indicating the relationship between the crank angle and the detected distance is advanced by 90°, and the phase between the solid line L1 indicating the relationship between the crank angle and the signal period and the solid line L3 indicating the relationship between the crank angle and the detected distance can be aligned. That is, an error due to eccentricity of the signal rotor 2 is calculated by differentiating the solid line L3.

Then, as illustrated in FIG. 5, to calculate a solid line L6 indicating the relationship between the crank angle and the signal period, correction is made by the alternate long and short dash line L5 obtained by differentiating the solid line L3 from the solid line L1 indicating the relationship between the crank angle and the signal period. Specifically, the scale of the alternate long and short dash line L5 is matched with the solid line L1, and an error (eccentric component) of the rotation angle due to eccentricity of the signal rotor 2 is subtracted from the solid line L1. As a result, the solid line L6 indicating the relationship between the corrected crank angle and the signal period is calculated, and the corrected output signal is obtained.

Therefore, according to the angle detection device 1 according to the present embodiment, the signal rotor 2 is provided with the angle detector 2E and the distance detector 2F along its axial direction. The first position detection sensor 3 is provided to face to the angle detector 2E in the radial direction of the signal rotor 2. The second position detection sensor 4 is provided to face the distance detector 2F in the radial direction and is disposed side by side with the first position detection sensor 3 in the axial direction.

According to this configuration, the first position detection sensor 3 and the second position detection sensor 4 can be easily disposed. The first position detection sensor 3 detects the rotation angle of the signal rotor 2, and the second position detection sensor 4 detects a distance from the signal rotor 2. Accordingly, the rotation angle detected by the first position detection sensor 3 can be corrected by the eccentricity of the signal rotor 2 detected by the second position detection sensor 4.

In addition, the signal rotor 2 has a cylindrical portion 2B, the angle detector 2E includes a plurality of notches 2f formed at equal angular intervals along the circumferential direction and a remaining portion 2G on one side in the axial direction in the cylindrical portion 2B, and the distance detector 2F includes a portion of the other side in the axial direction in the cylindrical portion 2B. The first position detection sensor 3 is disposed to face the outer peripheral surface on one side in the axial direction of the cylindrical portion 2B, and the second position detection sensor 4 is disposed to face the outer peripheral surface on the other side in the axial direction of the cylindrical portion 2B.

According to this configuration, the first position detection sensor 3 can detect a plurality of the notches 2f and the remaining portion 2G to detect the rotation angle of the crankshaft 6, and the second position detection sensor 4 can measure eccentricity of the signal rotor 2 based on a distance from the outer peripheral surface of the cylindrical portion 2B.

The first position detection sensor 3 and the second position detection sensor 4 are disposed to be substantially parallel to the axial direction. Therefore, the same position of the signal rotor 2 can be measured in the axial direction, and an error of the rotation angle between the first position detection sensor 3 and the second position detection sensor 4 can be suppressed.

Further, a rotation angle of the crankshaft 6 is detected based on a detection signal of the first position detection sensor 3, and the rotation angle of the crankshaft 6 detected by the first position detection sensor 3 is corrected based on a detection signal of the second position detection sensor 4 to calculate the rotation angle of the crankshaft 6. Thereby, the detection error of the rotation angle due to eccentricity of the signal rotor 2 can be corrected, and the detection error of the rotation angle can be suppressed.

The rotation angle of the crankshaft 6 is detected based on the detection signal of the first position detection sensor 3, the distance from the second position detection sensor 4 to the distance detector 2F of the signal rotor 2 is detected based on the detection signal of the second position detection sensor 4, and the rotation angle of the crankshaft 6 detected by the first position detection sensor 3 is corrected based on the detection signal of the second position detection sensor 4, to calculate the rotation angle of the crankshaft 6. Thereby, the detection error of the rotation angle due to eccentricity of the signal rotor 2 can be corrected, and the detection error of the rotation angle can be suppressed.

The rotation angle of the crankshaft 6 is detected based on the detection signal of the first position detection sensor 3, the distance from the second position detection sensor 4 to the distance detector 2F of the signal rotor 2 is detected based on the detection signal of the second position detection sensor 4, and the rotation angle of the crankshaft 6 detected by the first position detection sensor 3 is corrected based on a derivative of the detection signal of the second position detection sensor 4, to calculate the rotation angle of the crankshaft 6. Thereby, the detection error of the rotation angle due to eccentricity of the signal rotor 2 can be corrected, and the detection error of the rotation angle can be suppressed.

Note that the present invention is not limited to the above-described embodiments. Those skilled in the art can make various additions, modifications, and the like within the scope of the present invention.

### REFERENCE SIGNS LIST

1 angle detection device
2 signal rotor
3 first position detection sensor
4 second position detection sensor
5 ECU

1. An angle detection device, comprising a first position detection sensor, a second position detection sensor, and a signal rotor, the angle detection device being configured to detect a rotation angle of a rotating body to which the signal rotor is attached,
wherein the signal rotor is provided with an angle detector and a distance detector along an axial direction of the signal rotor,
the first position detection sensor is provided to face the angle detector in a radial direction of the signal rotor, and
the second position detection sensor is provided to face the distance detector in the radial direction and is disposed side by side with the first position detection sensor in the axial direction.

2. The angle detection device according to claim 1,
wherein the signal rotor has a cylindrical portion,
the angle detector includes a plurality of notches formed at equal angular intervals along a circumferential direction and a remaining portion on one side in the axial direction in the cylindrical portion,
the distance detector includes a portion on the other side in the axial direction in the cylindrical portion,
the first position detection sensor is disposed to face an outer peripheral surface on one side in the axial direction of the cylindrical portion, and
the second position detection sensor is disposed to face an outer peripheral surface on the other side in the axial direction of the cylindrical portion.

3. The angle detection device according to claim 1,
wherein the first position detection sensor and the second position detection sensor are disposed to be substantially parallel to the axial direction.

4. The angle detection device according to claim 1,
wherein a rotation angle of a rotation axis is detected based on a detection signal of the first position detection sensor, and
an angle of the rotation axis detected by the first position detection sensor is corrected based on a detection signal of the second position detection sensor to calculate an angle of the rotation axis.

5. The angle detection device according to claim 1,
wherein a rotation angle of the rotating body is detected based on a detection signal of the first position detection sensor,
a distance from the second position detection sensor to the distance detector of the signal rotor is detected based on a detection signal of the second position detection sensor, and
a rotation angle of the rotating body is calculated by correcting the rotation angle of the rotating body detected by the first position detection sensor based on a detection signal of the second position detection sensor.

6. The angle detection device according to claim 1,
wherein a rotation angle of the rotating body is detected based on a detection signal of the first position detection sensor,
a distance from the second position detection sensor to the distance detector of the signal rotor is detected based on a detection signal of the second position detection sensor, and
a rotation angle of the rotating body is calculated by correcting the rotation angle of the rotating body detected by the first position detection sensor based on a derivative of a detection signal of the second position detection sensor.
